(19) United States
(12) Patent Application Publication
(10) Pub. No.: US 2007/0241579 A1
(43) Pub. Date: Oct. 18, 2007

(54) File carrying device

(76) Inventor: Chun-Yuan Chang, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/405,179

(22) Filed: Apr. 18, 2006

(51) Int. Cl. A45F 5/12; A47J 45/00; B42F 13/02; B42F 1/00; B65D 85/00

(52) U.S. Cl. 294/138; 24/67.3; 402/21; 294/33; 206/425

(57) ABSTRACT

A file carrying device includes a carrying assembly having a plurality of connecting boxes connected with each other, and a plurality of files mounted on a respective one of the connecting boxes of the carrying assembly. Thus, each of the files is locked on and detached from the respective connecting box of the carrying assembly, so that each of the files is arranged easily and conveniently, thereby facilitating a user arranging each of the files. In addition, each of the files contains documents therein so that the each of the files can protect the documents to prevent the documents from being missed.

### BACKGROUND OF THE INVENTION

1. Field of the Invention

The present invention relates to a carrying device and, more particularly, to a file carrying device.

2. Description of the Related Art

A conventional file contains documents therein to facilitate a user filing and arranging the documents. However, the conventional file has a smaller volume, so that the documents carried by the file is limited, thereby limiting the versatility of the file. In addition, when a plurality of files are carried by a user at a time, the files are not connected or positioned, so that the files are not held by the user stably and easily slip from the user's hands, thereby causing inconvenience to the user.

### BRIEF SUMMARY OF THE INVENTION

In accordance with the present invention, there is provided a file carrying device, comprising a carrying assembly having a plurality of connecting boxes connected with each other, and a plurality of files mounted on a respective one of the connecting boxes of the carrying assembly.

The primary objective of the present invention is to provide a file carrying device, wherein each of the files is locked on and detached from the respective connecting box of the carrying assembly, so that each of the files is arranged easily and conveniently, thereby facilitating a user arranging each of the files.

Another objective of the present invention is to provide a file carrying device, wherein each of the files contains documents therein so that the each of the files can protect the documents to prevent the documents from being missed.

A further objective of the present invention is to provide a file carrying device, wherein the clamping member of each of the files is pivotable relative to the cover to clamp a piece of paper placed on the surface of the cover, thereby facilitating the user writing the paper.

A further objective of the present invention is to provide a file carrying device, wherein each of the files 1 is provided with a plurality of pivot plates each having a plurality of hanging holes so that the files are connected by the hanging holes, thereby facilitating the user connecting the files.

A further objective of the present invention is to provide a file carrying device, wherein each of the files is detached from the respective connecting box of the carrying assembly by pulling the pull tab outwardly, so that each of the files is removed from the respective connecting box easily and rapidly, thereby facilitating the user drawing each of the files.

A further objective of the present invention is to provide a file carrying device, wherein the file carrying device is provided with a handle to facilitate the user carrying the files.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a file in accordance with the preferred embodiment of the present invention.

FIG. 2 is a bottom perspective view of the file as shown in FIG. 1.

FIG. 3 is a locally enlarged perspective cross-sectional view of the file as shown in FIG. 1.

FIG. 4 is a perspective view of the file for clamping a piece of paper.

FIG. 5 is a perspective view of a file carrying device in accordance with the preferred embodiment of the present invention.

FIG. 6 is a plan cross-sectional view of the file carrying device as shown in FIG. 5.

FIG. 7 is a perspective view showing the files being placed on a file rack.

### DETAILED DESCRIPTION OF THE INVENTION

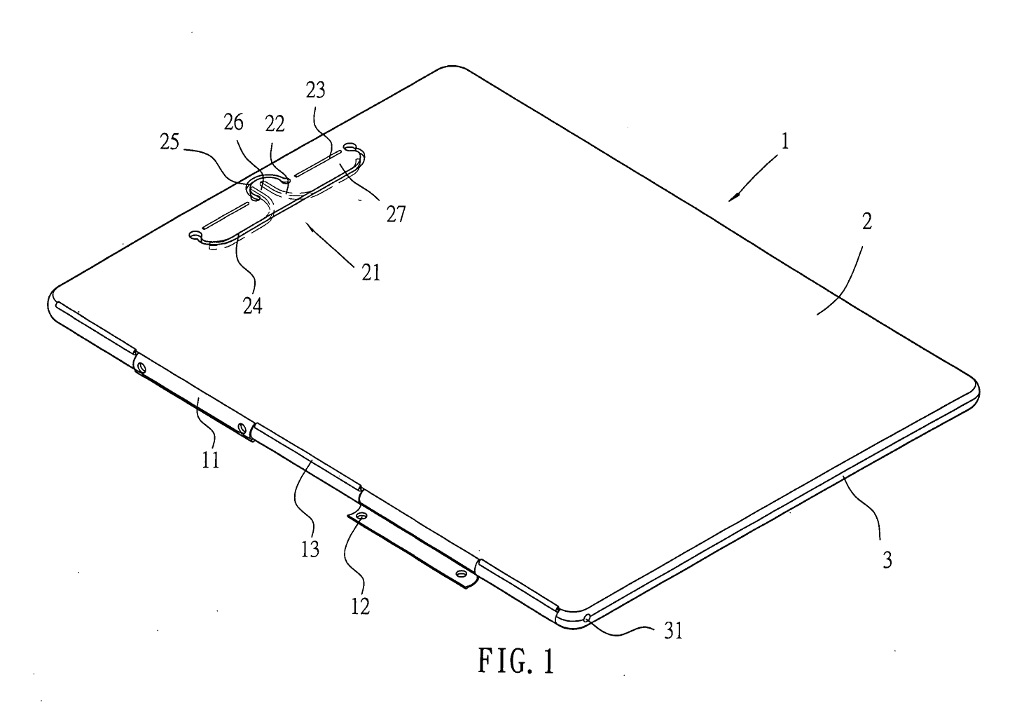

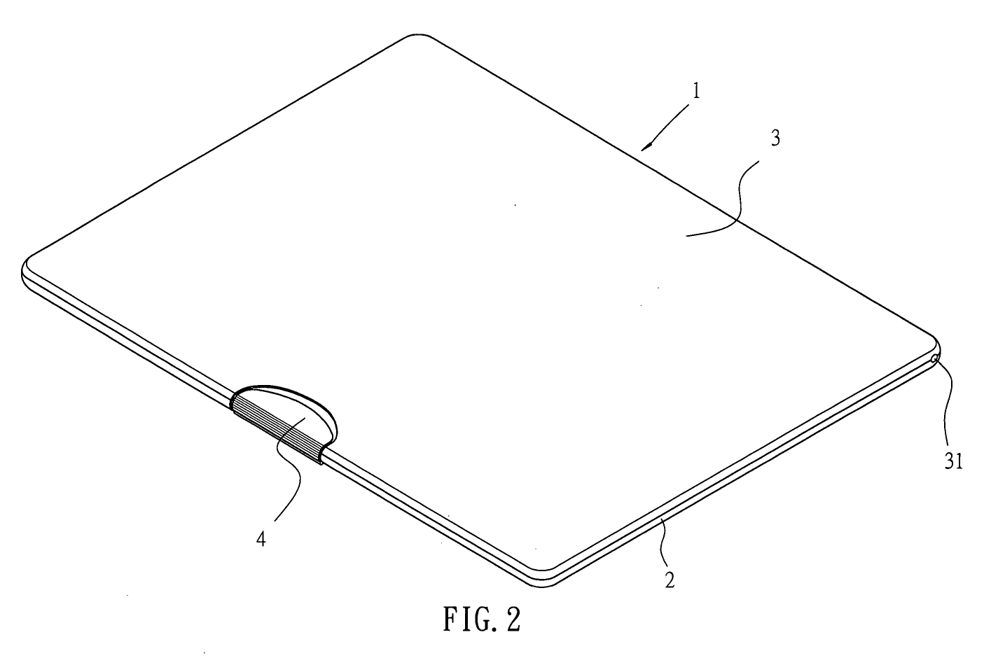

Referring to the drawings and initially to FIGS. 1-3, a box-shaped file 1 in accordance with the preferred embodiment of the present invention comprises a bottom plate 3, and a cover 2 mounted on the bottom plate 3.

The cover 2 has a first side pivotally mounted on a first side of the bottom plate 3 by a plurality of hinges 13 and a second side detachably locked onto a second side of the bottom plate 3 by a snapping member 4.

The file 1 further comprises a plurality of pivot plates 11 pivotally mounted on the first side of the cover 2 and the first side of the bottom plate 3. Each of the pivot plates 11 has a plurality of hanging holes 12 so that a plurality of files 1 are connected by the hanging holes 12 of the pivot plates 11. In addition, the file 1 is hung on a wall by the hanging holes 12 of the pivot plates 11.

The cover 2 has a surface provided with a flexible clamping member 21 that is pivotable relative to the cover 2. The clamping member 21 is hidden in the surface of the cover 2 at a normal state. The clamping member 21 has a first side formed with a substantially arc-shaped press portion 26 and a second side formed with an elongated driven portion 27 that is movable upward. relative to the cover 2 by pressing the press portion 26. The press portion 26 of the clamping member 21 is formed by a substantially arc-shaped opening 25, and the driven portion 27 of the clamping member 21 is formed by a substantially U-shaped slot 24.

The clamping member 21 has a mediate portion formed with a plurality of reinforcing ribs 23 located between the press portion 26 and the driven portion 27 to reinforce the strength of the clamping member 21, and the cover 2 has an inner side formed with a plurality of reinforcing ribs 22 surrounding the clamping member 21 to reinforce the strength of the cover 2.

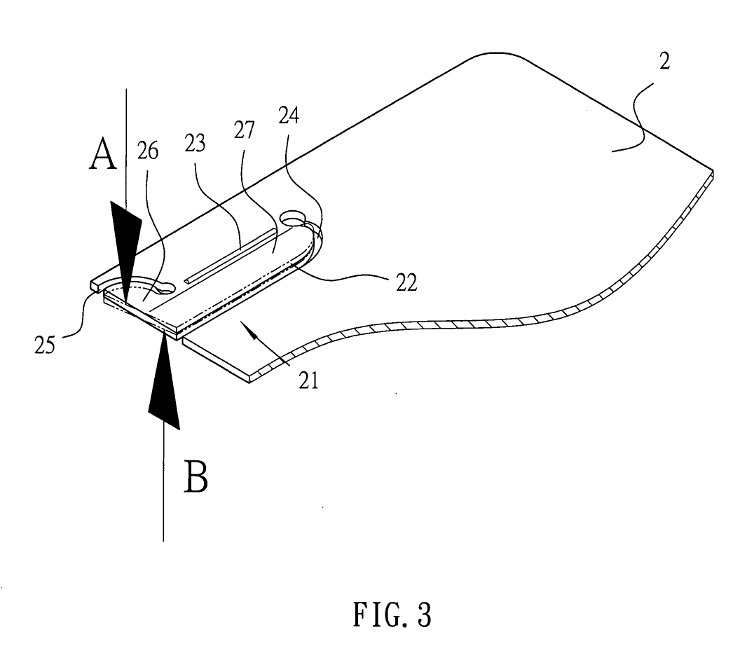

As shown in FIG. 3, when the press portion 26 of the clamping member 21 is pressed downward as indicated by the arrow “A”, the driven portion 27 of the clamping member 21 is movable upward relative to the cover 2 as indicated by the arrow “B”, so that the clamping member 21 is pivotable relative to the cover 2.

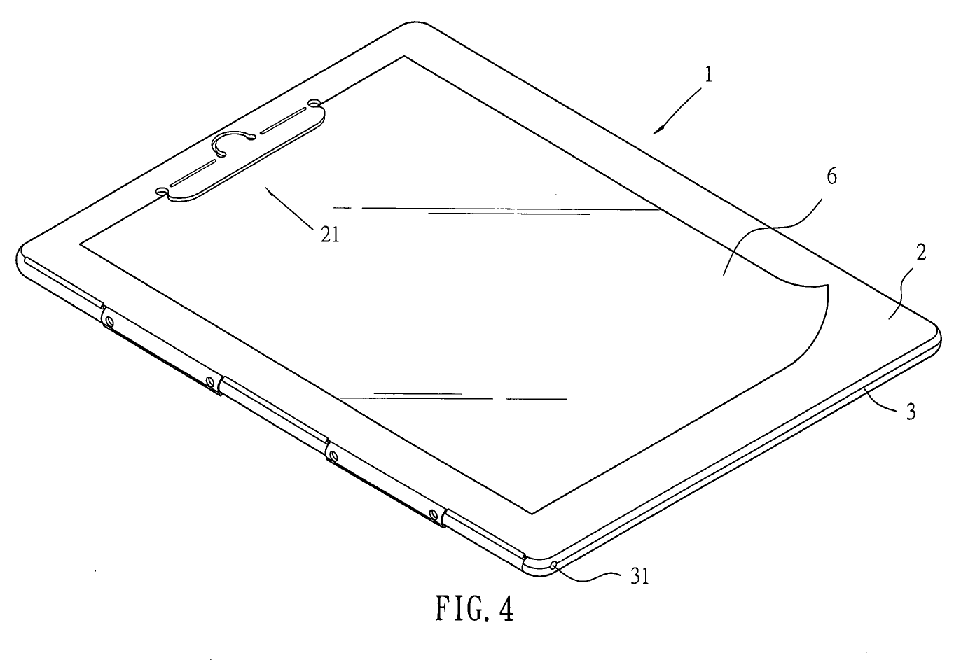

As shown in FIG. 4, the clamping member 21 is pivotable relative to the cover 2 to clamp a piece of paper 6 placed on the surface of the cover 2.

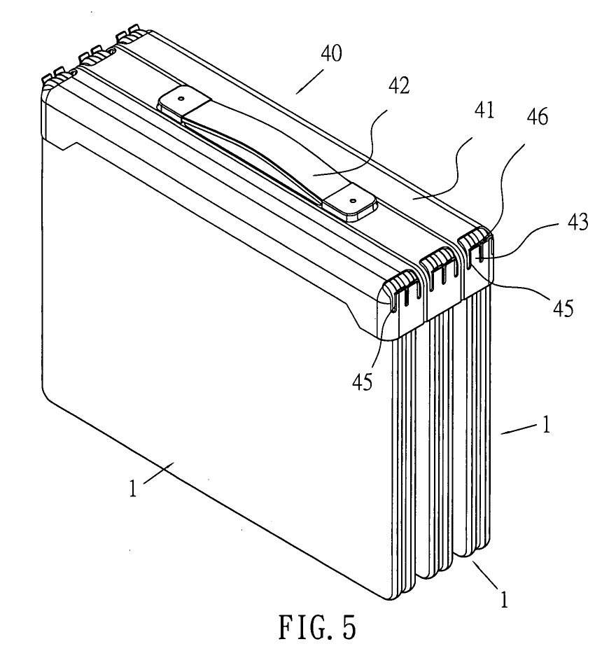

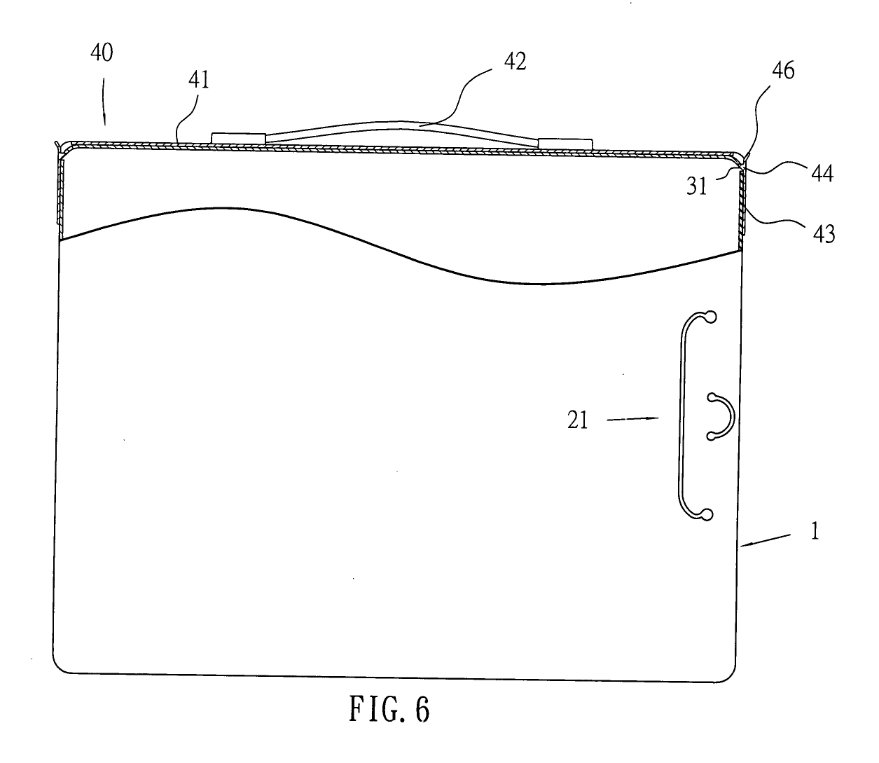

Referring to FIGS. 5 and 6 with reference to FIGS. 1-4, a file carrying device in accordance with the preferred embodiment of the present invention comprises a carrying assembly 40 having a plurality of connecting boxes 41 connected with each other, a handle 42 mounted on one of the connecting boxes 41 to carry the connecting boxes 41, and a plurality of files 1 mounted on a respective one of the connecting boxes 41 of the carrying assembly 40.

Each of the files 1 has two opposite ends each formed with a locking hole 31. Each of the connecting boxes 41 of the carrying assembly 40 has two opposite ends each provided with an elastic clamping plate 43 having an inside formed with a locking boss 44 detachably locked in the locking hole 31 of a respective one of the files 1. Thus, each of the files 1 is locked onto the respective connecting box 41 of the carrying assembly 40 by the elastic clamping plate 43.

The elastic clamping plate 43 of each of the connecting boxes 41 is formed by a slit 45 and has a distal end formed with a pull tab 46 protruded outwardly from each of the connecting boxes 41. The elastic clamping plate 43 of each of the connecting boxes 41 is movable outwardly relative to each of the connecting boxes 41 by pulling the pull tab 46 outwardly to move the locking boss 44 outwardly relative to the locking hole 31 of the respective file 1.

Thus, when the pull tab 46 of the elastic clamping plate 43 is pulled outwardly relative to the respective file 1, the elastic clamping plate 43 is movable outwardly to detach the locking boss 44 from the locking hole 31 of the respective file 1, thereby detaching one of the files 1 from the respective connecting box 41.

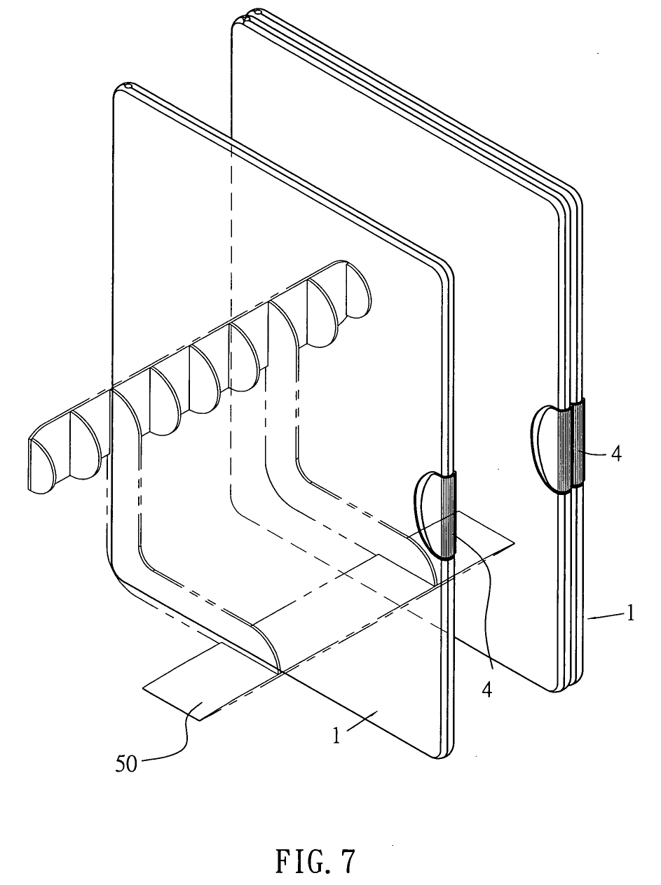

As shown in FIG. 7, the files 1 are placed on a file rack 50.

Accordingly, each of the files 1 is locked on and detached from the respective connecting box 41 of the carrying assembly 40, so that each of the files 1 is arranged easily and conveniently, thereby facilitating a user arranging each of the files 1. In addition, each of the files 1 contains documents therein so that the each of the files 1 can protect the documents to prevent the documents from being missed. Further, the clamping member 21 of each of the files 1 is pivotable relative to the cover 2 to clamp a piece of paper 6 placed on the surface of the cover 2, thereby facilitating the user writing the paper 6. Further, each of the files 1 is provided with a plurality of pivot plates 11 each having a plurality of hanging holes 12 so that the files 1 are connected by the hanging holes 12 of the pivot plates 11, thereby facilitating the user connecting the files 1. Further, each of the files 1 is detached from the respective connecting box 41 of the carrying assembly 40 by pulling the pull tab 46 outwardly, so that each of the files 1 is removed from the respective connecting box 41 easily and rapidly, thereby facilitating the user drawing each of the files 1. Further, the file carrying device is provided with a handle 42 to facilitate the user carrying the files 1.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A file carrying device, comprising:
a carrying assembly having a plurality of connecting boxes connected with each other;
a plurality of files mounted on a respective one of the connecting boxes of the carrying assembly.

2. The file carrying device in accordance with claim 1, wherein each of the files has two opposite ends each formed with a locking hole, and each of the connecting boxes of the carrying assembly has two opposite ends each provided with an elastic clamping plate having an inside formed with a locking boss detachably locked in the locking hole of a respective one of the files.

3. The file carrying device in accordance with claim 2, wherein each of the files is locked onto the respective connecting box of the carrying assembly by the elastic clamping plate.

4. The file carrying device in accordance with claim 2, wherein the elastic clamping plate of each of the connecting boxes is formed by a slit.

5. The file carrying device in accordance with claim 2, wherein the elastic clamping plate of each of the connecting boxes has a distal end formed with a pull tab protruded outwardly from each of the connecting boxes.

6. The file carrying device in accordance with claim 5, wherein the elastic clamping plate of each of the connecting boxes is movable outwardly relative to each of the connecting boxes by pulling the pull tab outwardly to move the locking boss outwardly relative to the locking hole of the respective file.

7. The file carrying device in accordance with claim 5, wherein when the pull tab of the elastic clamping plate is pulled outwardly relative to the respective file, the elastic clamping plate is movable outwardly to detach the locking boss from the locking hole of the respective file, thereby detaching one of the files from the respective connecting box.

8. The file carrying device in accordance with claim 1, further comprising a handle mounted on one of the connecting boxes to carry the connecting boxes.

9. The file carrying device in accordance with claim 1, wherein each of the files comprises a bottom plate, and a cover mounted on the bottom plate.

10. The file carrying device in accordance with claim 9, wherein the cover has a first side pivotally mounted on a first side of the bottom plate by a plurality of hinges and a second side detachably locked onto a second side of the bottom plate by a snapping member.

11. The file carrying device in accordance with claim 9, wherein each of the files further comprises a plurality of pivot plates pivotally mounted on the first side of the cover and the first side of the bottom plate.

12. The file carrying device in accordance with claim 11, wherein each of the pivot plates has a plurality of hanging holes.

13. The file carrying device in accordance with claim 9, wherein the cover has a surface provided with a flexible clamping member that is pivotable relative to the cover.

14. The file carrying device in accordance with claim 13, wherein the clamping member is hidden in the surface of the cover at a normal state.

15. The file carrying device in accordance with claim 13, wherein the clamping member has a first side formed with a press portion and a second side formed with an elongated driven portion that is movable upward relative to the cover by pressing the press portion.

16. The file carrying device in accordance with claim 15, wherein the press portion of the clamping member is substantially arc-shaped.

17. The file carrying device in accordance with claim 1, wherein the press portion of the clamping member is formed by a substantially arc-shaped opening.

18. The file carrying device in accordance with claim 1, wherein the driven portion of the clamping member is formed by a substantially U-shaped slot.

19. The file carrying device in accordance with claim 1, wherein the clamping member has a mediate portion formed with a plurality of reinforcing ribs located between the press portion and the driven portion to reinforce the strength of the clamping member.

20. The file carrying device in accordance with claim 1, wherein the cover has an inner side formed with a plurality of reinforcing ribs surrounding the clamping member to reinforce the strength of the cover.
